(19) United States
(12) Patent Application Publication
(10) Pub. No.: US 2025/0178511 A1
(43) Pub. Date: Jun. 5, 2025

(54) SQUARE-SHAPED SERVICE SERVING ROBOT WITH EXCELLENT SERVICE PROVISION SPACE UTILIZATION

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 18/259,988

(22) PCT Filed: Jun. 26, 2023
(86) PCT No.: PCT/KR2023/008875

§ 371 Date: Dec. 2, 2024

(30) Foreign Application Priority Data
Mar. 30, 2023 (KR) 10-2023-0041871

(51) Int. Cl. B60P 3/00; B25J 11/00

(52) U.S. Cl. CPC B60P 3/007; B25J 11/008

(57) ABSTRACT

Disclosed is a square-shaped service serving robot with an excellent service provision space utilization and, more specifically, to a square shaped service serving robot with an excellent service provision space utilization that it serves various services to be provided to customers, 5 provides a tableware return function depending on the situation, and maximizes driving safety and stability of the service serving robot by including sensors capable of detecting and recognizing obstacles and flow status information in real time, thereby promoting the usability and effectiveness of the service serving robot and the safety of the store.

### TECHNICAL FIELD

The present invention relates to a square-shaped service serving robot with an excellent service provision space utilization and, more specifically, to a square-shaped service serving robot with an excellent service provision space utilization that it serves various services to be provided to customers, provides a tableware return function depending on the situation, and maximizes driving safety and stability of the service serving robot by including sensors capable of detecting and recognizing obstacles and flow status information in real time, thereby promoting the usability and effectiveness of the service serving robot and the safety of the store.

### BACKGROUND ART

In the service industry that provides services such as restaurants, recently, the problem of service response is emerged, and the introduction of a 52-hour workweek and the increase in the minimum wage are in progress, increasing the burden of labor costs. Accordingly, the unmanned service market that does not employ employees has been rapidly expanded.

In particular, a KIOSK, which is an unmanned information guide system for providing unmanned orders and payments, is actively used by the service companies.

However, in a case of the service that provides foods or drinks completed through a cooking or a processing, the development of the unmanned technology is insufficient.

Due to the insufficiency of such technology development, currently, in Korea, the demand for the serving robots is being met by importing and then, selling or leasing the serving robots.

However, since these imported serving robots are rather expensive, one serving robot is a burden on restaurant companies in terms of economic efficiency and productivity.

Therefore, at a time when companies are considering new types of restaurants such as futuristic and unmanned restaurants, there is an urgent need for domestically developed products that are inexpensive and have excellent functions.

In food service companies and restaurant business such as restaurants, coffee shops, fast-food restaurants, family restaurants, and special restaurants as well as the industries that require various services such as museums, department stores, and public institutions, even without expensive equipment, the present invention intends to provide a square-shaped service serving robot with an excellent service robot usability that can satisfy the needs of customers on behalf of employees and guides as well as even perform the tableware return function, based on the provision of various services, and promote the usability, effectiveness, and stability of the service serving robot and the safety of the store by including sensors capable of detecting and recognizing obstacles and floor status information in real time.

Accordingly, as a prior art for the square-shaped service serving robot with the excellent service robot usability, “a moving robot and a control method thereof” of Korean Patent Laid-Open Publication No. 10-2019-0106910 (hereinafter referred to as “Patent Literature 1”) is disclosed.

Patent Literature 1 relates to a moving robot and a control method thereof of providing the control method for the moving robot includes: a step of receiving user input including a predetermined service request by a moving robot; a step of receiving an article to be served, by the moving robot; a step of extracting a serving position by searching a user and analyzing a user's gesture by the moving robot; a step of extracting the distance and height of the serving position by analyzing an image of the serving position; a step of moving to the serving position and lifting the article to be served to the height of the serving position; and a step of horizontally moving the article to be served to the serving position and placing the article to be served at the serving position.

As another prior art, “a serving robot and a customer serving method using the same” of Korean Patent Laid-Open Publication No. 10-2019-0092337 (hereinafter referred to as “Patent Literature 2”) is disclosed.

In Patent Literature 2, the serving robot incudes a camera for obtaining image data including at least one of an expression and a gesture of a customer associated with food; a microphone for obtaining voice data including a voice of a customer associated with the food; and a processor for obtaining customer response data including at least one of the image data and the voice data through at least one among the camera and the microphone, estimating a response of the customer to the food from the obtained customer response data, and generating or updating customer management information corresponding to the customer on the basis of the estimated response. According to the embodiment, the serving robot can estimate a customer's response from the customer response data through an artificial intelligence-based learning model.

As described above, Patent Literatures 1 and 2 are technologies related to the serving robot that responds to the customer in the field, and has the same technical field as the present invention, however the technical characteristics of the invention are different from each other.

That is, Patent Literatures 1 is a technology for a serving robot that allows the user to directly withdraw the serving article accommodated by the serving robot from the user's desired location to provide it to the user, without withdrawing the serving article by means of the user.

Patent Literature 2 is a technology for a serving robot that can easily identify and manage the tastes of customers using the restaurant, by estimating the customer's response (food-related customer expression and gesture) from customer response data obtained by using a camera or a microphone and updating management information about the customers.

Accordingly, Patent Literature 1 and Patent Literature 2 are different from the present invention in terms of the problem to be solved by the invention, the means for solving the problem, and the effect exerted by solving the problem.

Accordingly, the present invention is different from the technology for the conventional service serving robots including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Laid-Open Publication No. 10-2019-0106910 (Sep. 18, 2019)
Patent Literature 2: Korean Patent Laid-Open Publication No. 10-2019-0092337 (Aug. 7, 2019)

### DISCLOSURE

### Technical Problem

In this respect, the present invention is made to solve the above-described problem in the related art, and an object of the present invention is to provide to a square-shaped service serving robot with an excellent service provision space utilization in that it is formed in a square shape, so that the utilization of the service space, where various services are provided to customers, can be maximized and a plurality of sensors capable of detecting and recognizing obstacles and floor status information in real time while the service serving robot is driving can be provided therein, so that the driving safety and stability can be maximized.

Another object of the present invention is to provide to a square-shaped service serving robot with an excellent service provision space utilization in that it performs a role of performing services to the customers and allows the tableware return function to be performed depending on the situation, so that the use of a separate mobile equipment for the tableware return function can be restricted and the congestion in the store can be prevented, thereby providing better service by delivering a sense of comfort and security to the customers.

### Technical Solution

According to one aspect of the present invention so as to accomplish these objects, there is provided to a square-shaped service serving robot with an excellent service provision space utilization including:
a service serving tray housing means formed in a rectangular shape and providing a tableware return functions to customers; and
a serving robot driving means that is located and formed at a lower end of the service serving tray housing means, and moves, waits, and stops along a destination or a path input and transmitted from an outside to provide various services and the tableware return function to customers through the service serving tray housing means,
wherein the service serving tray housing means and serving robot driving means are formed in a layered structure to provide various services and the tableware return function to the customers,
wherein the service serving tray housing means includes:
a service serving tray base frame housing formed of a rectangular base frame and passed through a center of the base frame;
a first service providing means that is located at an upper end of service serving tray base frame housing and has one or more service providing holder grooves formed with a certain diameter and a certain depth so as to exclusively provide drinks and utensils to the customers;
a second service providing means that is located at a lower portion of the first service providing means and having one or more service providing trays formed in a layered structure so as to provide various services to the customers; and
a third service providing means that is located at a lower portion of the second service providing means, provides various services to the customers in the same way as the second service providing means, and outputs real-time status information of the service serving tray housing means, so that the store manager can intuitively recognize the real-time status information on the service serving tray housing means, and
wherein, through the square-shaped service serving tray housing means and the service providing tray, a utilization of the service providing space is maximized, so that various services can be easily provided to the customers.

At this time, on one side of the upper portion of the service serving tray housing means, the first sensor element is configured, so that real-time obstacles located within a certain range in the upper and lower directions based on an arbitrary upper side of the service serving robot can be recognized and avoided, when the service serving robot is driving; and
on one side of the upper portion of the service serving robot driving means, a second sensor element is configured, so that real-time obstacles located within a certain range in the upper and lower directions and driving floor status information thereof based on an arbitrary lower side of the service serving robot can be recognized and avoided, when driving the service serving robot, so that it maximizes the driving safety and stability of the service serving robot by securing the field of view necessary for driving and obstacle avoidance of the service serving robot.

In addition, depending on the situation, the service providing tray for providing various services to the customers is placed on the upper portion of the first service providing means, so that it can be utilized as the same function as the second service providing means and the third service providing means that provide the services to the customers, so that it promotes easy structural change of the serving robot service, thereby maximizing utilization and effectiveness of the service serving robot.

In addition, the first service providing means, the second service providing means, and the third service providing means are provided with the service providing trays for providing various services to the customers and the tableware return function activation bowls capable of collecting the remaining tableware after the service is completed by the customers respectively, depending on circumstances, so that it promotes easy structural change of the serving robot service providing means according to the situation, thereby providing various services as well as activating the tableware return function.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above with respect to the above configuration and operation, the effects of the present invention are as follows.

1. By forming the service serving robot in a square shape, the utilization on the service provision space to be provided to the customers is maximized, so that the service provision space can be used more widely.

In other words, compared to a round service serving robot of the same standard, the service provision space is formed by approximately 1.3 times, thereby maximizing the service provision space utilization (The formula for the area of a circle is ‘πr² (r is the radius)’ and the formula for the area of a rectangle is ‘width×height’ and thus, if the length of the rectangle and the diameter of the circle are the same, the area of the rectangle is about 1.3 times larger).

2. It can maximize the utilization and the effectiveness of the service serving robot by providing various services and customer response including the tableware return function that should be conducted inside the store through the service serving robot.

3. In addition, it is possible to perform the customer response, the service providence, and the tableware return function with only the service serving robot inside the store, without the need for separate mobile equipment required for the service providence and the tableware return, so that the congestion inside the store is prevented and the customers feel comfortable and secure, thereby providing better service to the customers.

4. In addition, since the congestion inside the store is prevented, the driving convenience and stability of the service serving robot are maximized.

That is, by promoting the simplicity of the interior of the store, the stabilization of the obstacle avoidance ability is induced when the service serving robot is driving.

5. In addition, various sensors capable of detecting and recognizing obstacles and floor status information in real time are further included to maximize driving safety and stability.

6. in addition, depending on the situation, it can maximize the ease of transporting the collected tableware, etc. to the kitchen by utilizing the tableware return function activation bowl that can collect tableware left by the customer (after the service provided by the customer is completed).

7. In addition, depending on the situation, in relation to a service serving robot that focuses on providing services to the customers and a service serving robot that can intensively perform the tableware return function, one service serving robot that can properly mix and perform two functions (service providing function and tableware return function) can be easily structurally changed and utilized according to the purpose of the situation, thereby easily changing the purpose of the service serving robot and maximize the utilization and effectiveness thereof.

That is, as described above, the present invention is a very effective invention that the service serving robot not only responds to the customers and provides various services to the customers, but also has the tableware return function to collect the tableware remaining after the service is completed by the customer, and includes sensors capable of detecting and recognizing obstacles and floor status information in real time, so that it can maximize the usability and effectiveness of the service serving robot and driving safety and stability thereof.

### BRIEF DESCRIPTION OF DRAWINGS

The above and other objects, features and advantages of the present invention will be more apparent from the following detailed description taken in conjunction with the accompanying drawings, in which:

FIG. 1 illustrates a block diagram of a square-shaped service serving robot with excellent service provision space utilization according to the present invention;

FIG. 2 is a perspective view illustrating a state of an embodiment of a square-shaped service serving robot with excellent service provision space utilization according to the present invention;

FIG. 3 is an exploded perspective view illustrating an embodiment of a square-shaped service serving robot with excellent service provision space utilization according to the present invention; and

FIG. 4 is a reference drawing illustrating an embodiment of a square-shaped service serving robot with excellent service provision space utilization according to the present invention (perspective view, front view, rear view).

### REFERENCE SIGNS LIST

1: Square-shaped service serving robot with excellent service provision space utilization
100: Service serving tray housing means
110: First service providing means
111: Service serving robot information output display element
112: First service providing tray non-slip seating pad element
113: First service providing tray position guide protruding surface element
114: First sensor element
115: Emergency action stop button element
120: Second service providing means
121: Tray support base mold element
122: Second service providing tray non-slip seating pad element
123: Second service providing tray position protruding surface element
130: Third service providing means
131: Tray support floor space element
132: Service serving robot real-time status output LED element
133: Third service provision tray non-slip seating pad element
134: Third service providing tray position guide protruding surface element
200: Service serving robot driving means
210: Rechargeable power supply element
211: Rechargeable battery
212: Battery removable door window
220: Moving power element
230: Second sensor element
231: Camera sensor
232: Lidar sensor
233: Ultrasonic sensor
234: Infrared sensor
300: Service serving robot control unit
310: Driving space creation module
311: SLAM execution element
312: Creation map correction element
313: Creation map 2D conversion element
314: Final driving space map creation element
320: Path setting module
321: Driving path execution element
322: Driving path validation element
323: local/global path return setting element
324: Driving difference correction element
330: Service serving robot drive control module
H: Service serving tray base frame housing
CH: Service provision holder groove
TR: Servicing tray
BW: Tableware return function activation bowl

### BEST MODE

### Mode for Invention

Hereinafter, functions, configurations, and operations effects of a square-shaped service serving robot (1) with excellent service provision space utilization according to the present invention will be described in detail with reference to the accompanying drawings.

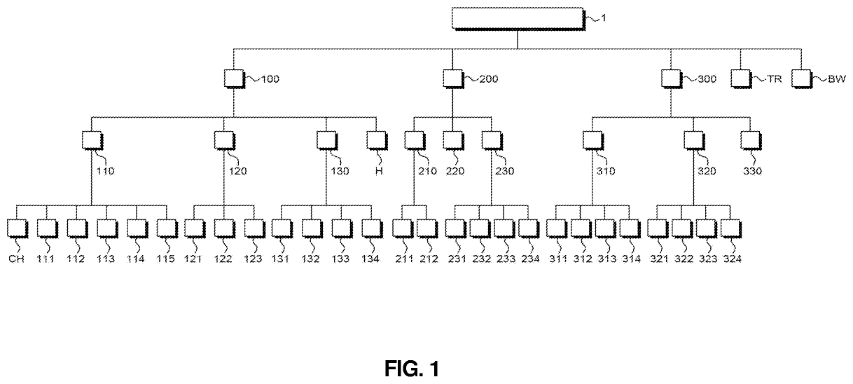

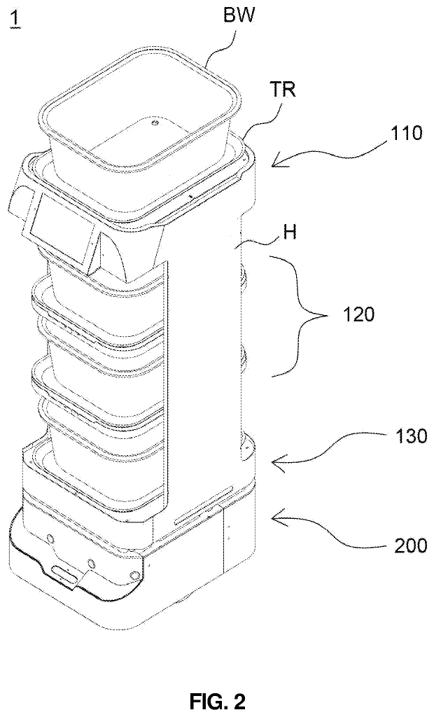

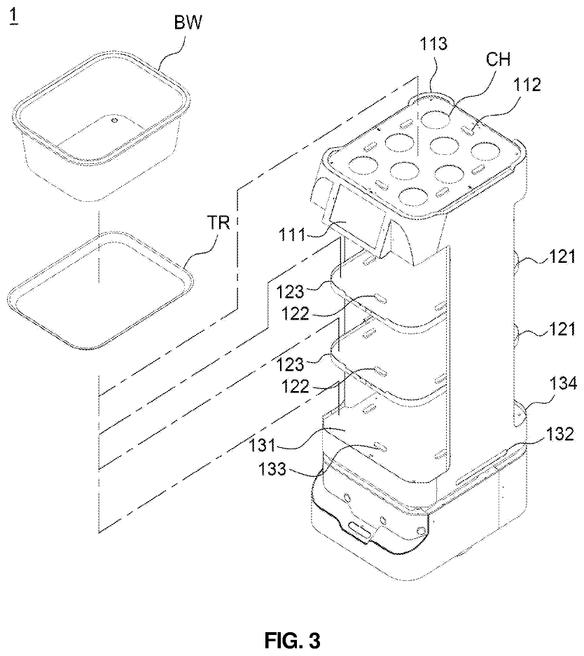

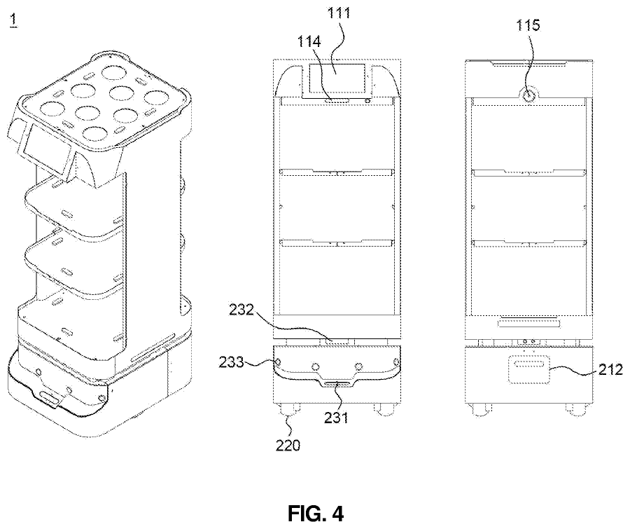

FIG. 1 illustrates a block diagram of a square-shaped service serving robot with excellent service provision space utilization according to the present invention; FIG. 2 is a perspective view illustrating a state of an embodiment of a square-shaped service serving robot with excellent service provision space utilization according to the present invention; FIG. 3 is an exploded perspective view illustrating an embodiment of a square-shaped service serving robot with excellent service provision space utilization according to the present invention; and FIG. 4 is a reference drawing illustrating an embodiment of a square-shaped service serving robot with excellent service provision space utilization according to the present invention.

As shown in FIG. 1 to FIG. 4, a square-shaped service serving robot (1) with an excellent service provision space utilization according to the present invention:
a service serving tray housing means (100) formed in a rectangular shape and providing a tableware return functions to customers; and
a serving robot driving means (200) that is located and formed at a lower end of the service serving tray housing means (100), and moves, waits, and stops along a destination or a path input and transmitted from an outside to provide various services and the tableware return function to customers through the service serving tray housing means (100).

The service serving tray housing means (100) and the serving robot driving means (200) are formed in a layered structure to provide various services and the tableware return function to the customers.

The service serving tray housing means (100) includes:
a service serving tray base frame housing (H) formed of a rectangular base frame and passed through a center of the base frame;
a first service providing means (110) that is located at an upper end of a service serving tray base frame housing (H) and has one or more service providing holder grooves (CH) formed with a certain diameter and a certain depth so as to exclusively provide drinks and utensils to the customers;
a second service providing means (120) that is located at a lower portion of the first service providing means (110) and having one or more service providing trays (TR) formed in a layered structure so as to provide various services to the customers; and
a third service providing means (130) that is located at a lower portion of the second service providing means (120), provides various services to the customers in the same way as the second service providing means (120), and outputs real-time status information of the service serving tray housing means (100), so that the store manager can intuitively recognize the real-time status information on the service serving tray housing means (100).

Accordingly, through the square-shaped service serving tray housing means (100) and the service providing tray (TR), the utilization of the service providing space is maximized, so that various services can be easily provided to the customers.

That is, as described above, the present invention relates to a square-shaped service serving robot (1) with excellent service provision space utilization that, through the service serving robot, not only responds to customers including providing various services inside the store, but also collects the tableware left by the customers in a specific space through the activation of the tableware return function after the service is used. In addition, by including various sensors that detect and recognize obstacles and floor condition information in real time, the usability and effectiveness of the service serving robot and the driving stability can be maximized.

The present invention will be described in more detail as follows.

The service serving tray housing means (100), as described above, includes:
a service serving tray base frame housing (H) formed of a rectangular base frame and passed through a center of the base frame;
a first service providing means (110) that is located at an upper end of service serving tray base frame housing (H) and has one or more service providing holder grooves (CH) formed with a certain diameter and a certain depth so as to exclusively provide drinks and tableware to the customers;
a second service providing means (120) that is located at a lower portion of the first service providing means (110) and having one or more service providing trays (TR) formed in a layered structure so as to provide various services to the customers; and
a third service providing means (130) that is located at a lowest portion of the second service providing means (120), provides various services to the customers in the same way as the second service providing means (120), and outputs real-time status information of the service serving tray housing means (100) so as to in order to intuitively recognize the real-time status information on the service serving tray housing means (100) by means of the store manager.

More concretely, the first service providing means (110) includes:

One or more service providing holder grooves (CH) formed with a certain diameter and a certain depth so as to exclusively provide drinks and utensils to the customers and formed in a certain pattern;
a service serving robot information output display module (111) that outputs various service information (menu) and emoticons related to the status of the service serving robot to the customers on one side of an outer circumferential surface thereof to provide information to the customers;
one or more first service providing tray non-slip seating pad elements (112) that are positioned and formed in a certain arrangement on one side of an upper surface thereof, and are in contact with one side of the lower surface of the service providing tray (TR) to prevent a slipping of the service providing tray (TR) from the first service providing means (110) in advance, when the service providing tray (TR) and a tableware return function activation bowl (BW) are located thereon according to circumstances, and absorbs a transmission of a vibration generated during service serving robot driving to the service tray (TR) and the tableware return function activation bowl (BW) by closing the service providing holder groove (CH) to maximize positional stability of the service providing tray (TR) and the tableware return function activation bowl (BW);
a first service providing tray position guide protruding surface element (113) that protrudes from an end of an outer circumferential surface thereof at a certain height in the upward direction to promote positional stability of the service providing tray (TR) and the tableware return function activation bowl (BW) along with the first service tray non-slip seating pad element (112);
a first sensor element (114) that is located and formed on one side of the outer circumferential surface, detects and recognizes obstacles in real time while the service serving robot is driving, and acquires information to avoid the obstacles; and
an emergency action stop button element (115) that is located and formed on one side of an outer circumferential surface and is physically pressurized when a problem occurs in the service serving robot to stop the service serving robot.

Accordingly, the store's service information (menu) is output, so that the intimacy of the service serving robot is induced, and depending on the situation, the service providing tray (TR) and the tableware return function activation bowl (BW) are placed in the first service providing means (110), so that it is changed as the role of the service providing means (120), thereby performing the function of the second service providing means (120).

At this time, the first sensor element (114), for example, a camera sensor capable of recognizing the obstacles in real time may be applied when the service serving robot is driving.

The second service providing means (120) includes:
One or more tray support base mold elements (121) are formed in a layered structure at regular intervals so as to place the service providing tray (TR) and the tableware return function activation bowl (BW) thereon;
one or more second service providing tray non-slip seating pad elements (122) that are positioned and formed in a certain arrangement on one side of an upper surface of the tray support base mold elements (121), and are in contact with one side of the lower surface of the service providing tray (TR) to prevent a slipping of the service providing tray (TR) and the tableware return function activation bowl (BW) from the tray support base mold element (121) in advance, when the service providing tray (TR) and the tableware return function activation bowl (BW) are located thereon according to circumstances, and absorbs a transmission of a vibration generated during service serving robot driving to the service providing tray (TR) and the tableware return function activation bowl (BW) to maximize positional stability of the service providing tray (TR) and the tableware return function activation bowl (BW); and
a second service providing tray position guide protruding surface element (123) that protrudes from an end of an outer circumferential surface of the tray support base mold element (121) at a certain height in the upward direction to promote positional stability of the service providing tray (TR) and the tableware return function activation bowl (BW) along with the second service providing tray non-slip seating pad element (122).

Accordingly, depending on the situation, the service providing tray (TR) and the tableware return function activation bowl (BW) are placed and positioned on the tray support base mold element (121), so that various services can be provided to the customers, or the tableware return function which collects the tableware, etc. remaining after the service is completed by the customers is activated.

The third service providing means (130) includes:
a tray support floor space element (131) that places and positions the service provision tray (TR) and the tableware return function activation bowl (BW) thereon;
a service serving robot real-time status output LED module (132) that is located and formed on one or more of the four outer peripheral surfaces thereof and outputs the real-time status of the service serving robot through one or more of different colors and blinking, so that the store manager can visually check the real-time status of the service serving robot;
one or more third service providing tray non-slip seating pad elements (133) that are positioned and formed in a certain arrangement on one side of an upper surface of the tray support floor space element (131), and are in contact with one side of the lower surface of the service providing tray (TR) to prevent a slipping of the service providing tray (TR) and the tableware return function activation bowl (BW) from the tray support floor space element (131) in advance, when the service providing tray (TR) and the tableware return function activation bowl (BW) are located thereon according to circumstances, and absorbs a transmission of a vibration generated during service serving robot driving to the service providing tray (TR) and the tableware return function activation bowl (BW) to maximize positional stability of the service providing tray (TR) and the tableware return function activation bowl (BW); and
a third service providing tray position guide protruding surface element (134) that protrudes from an end of an outer circumferential surface of the tray support floor space element (131) at a certain height in the upward direction to promote positional stability of the service providing tray (TR) and the tableware return function activation bowl (BW) along with the third service providing tray non-slip seating pad element (133).

Similarly to the first service providing means (110) and the second service providing means (120), various services are provided to the customers according to the situation and the tableware return function can be activated. In addition, the real-time status information of the service serving tray housing means (100) is output, so that the store manager can intuitively recognize the real-time status information on the service serving tray housing means (100).

As an example, in order to maximize the serving function capable of providing various services to the customers, the service providing trays (TR) are mounted on the first service providing means (110), the second service providing means (120), and the third service providing means (130).

In addition, in order to maximize the tableware return function, the tableware return function activation bowls (BW) are mounted on the first service providing means (110), the second service providing means (120), and the third service providing means (130), so that the tableware, etc. remaining after the service is completed by the customers can be quickly collected.

That is, in the case of the service serving tray housing means (100) of the present invention, depending on the situation, the service providing tray (TR) for providing various services to the customers is placed on the upper portion of the first service providing means (110), so that it can be utilized as the same function as the second service providing means (120) and the third service providing means (130) that provide the services to the customers.

In addition, the first service providing means (110), the second service providing means (120), and the third service providing means (130) are provided with the service providing trays (TR) for providing various services to the customers and the tableware return function activation bowls (BW) capable of collecting the remaining tableware after the service is completed by the customers respectively, depending on circumstances, so that it promotes easy structural change of the serving robot service providing means (100) according to the situation, thereby providing various services as well as activating the tableware return function according to the maximization of utilization and effectiveness of the service serving robot.

That is, the first service providing means (110), the second service providing means (120), and the third service providing means (130) can be utilized according to their respective roles and functions, but, they can be used in various roles and functions through the service providing tray (TR) and the tableware return function activation bowl (BW).

The service serving robot driving means (200) is formed of a set of mechanical elements to be physically operated, in order to perform the movement of the service serving robot including the driving means such as wheels, shafts, motors, inverters, etc. necessary for driving the service serving robot and specific tasks (providing various services to customers and activating the tableware return function) and it is formed as a set of mechanical elements that must be physically operated.

More concretely, the service serving robot driving means (200) includes:
a rechargeable power supply element (210) located on one side of an inside thereof and detachable from the service serving robot to supply a main power to the service serving robot;
a moving power element (220) formed on one side of a lower portion thereof, so that the service serving robot can drive; and
second sensor elements (230) located and formed on one side of an upper portion, a lower portion, and an outer circumferential surface thereof, so that information necessary for driving and avoiding obstacles is acquired in real time.

The rechargeable power supply element (210) includes:
a rechargeable battery (211) that supplies the main power to the service serving robot; and
a battery removable door window (212) that can be opened and closed and formed on one side of the outer circumferential surface of the service serving robot driving means (200), so that the rechargeable battery (211) can be inserted and positioned into the service serving robot driving means (200).

Accordingly, through the opening and closing of the battery removable door window (212), the rechargeable battery (211) can be easily mounted and detached into the service serving robot driving means (200). Therefore, when an abnormality including a discharge of the service serving robot occurs, the rechargeable battery (211) can be easily replaced, so that the management of the service serving robot becomes easy.

In addition, the second sensor element (230) includes:
a camera sensor (231) that is located and formed on one side of an outer circumferential surface of the service serving robot driving means (200) and obtains information to avoid the obstacles by detecting and recognizing the obstacles in real time when the service serving robot is driving;
a LIDAR sensor (232) that is located and formed on one side of the upper portion of the service serving robot driving means (200) and obtain store information for driving of the service serving robot;
an ultrasonic sensor (233) that is located and formed on one side of the outer circumferential surface of the service serving robot driving means (200) and obtains information to avoid the obstacles by detecting and recognizing the obstacles in real time when the service serving robot is driving, with the same role as the camera sensor (231); and
an infrared sensor (234) that is located and formed on one side of a lower portion of the service serving robot driving means (200) and preventing a fall by detecting the driving floor status of the service serving robot in real time.

Accordingly, the store information, the obstacle information, and the floor status information required for driving of the service serving robot are acquired in real time, so that the service serving robot can safely drive on an optimal path.

That is, on one side of the upper portion of the service serving tray housing means (100), the first sensor element (114) is configured, so that real-time obstacles located within a certain range in the upper and lower directions based on an arbitrary upper side of the service serving robot can be recognized and avoided, when the service serving robot is driving.

In addition, on one side of the upper portion of the service serving robot driving means (200), a second sensor element (230) is configured, so that real-time obstacles located within a certain range in the upper and lower directions and driving floor status information thereof based on an arbitrary lower side of the service serving robot can be recognized and avoided, when driving the service serving robot.

Accordingly, it maximizes the driving safety and stability of the service serving robot by securing the field of view necessary for driving and obstacle avoidance of the service serving robot.

On the other hand, the square-shaped service serving robot (1) with excellent service provision space utilization according to the present invention further includes:
a service serving robot control unit (300) that controls the service serving robot for the movement of the service serving robot and the specific tasks (providing various services to customers and activating the tableware return function).

The service serving robot control unit (300) controls the serving robot driving means (200) so that the service serving robot operates smoothly according to the movement of the service serving robot and the specific tasks (providing various services to customers and activating the tableware return function).

More concretely, the service serving robot control unit (300) includes:
a driving space creation module (310) that creates a driving space of the serving robot, which is operated and driven by the serving robot driving means (300);
a path setting module (320) for creating and setting a driving path of the serving robot is configured, based on the information created from the driving space creation module (310); and
a service serving robot drive control module (330) that transmits a signal to the serving robot driving means (200) to move the service serving robot, when it creates and sets the driving path through the path setting module (320) according to the mission of the service serving robot, based on the driving space information of the service serving robot created by the driving space creation module (310).

Accordingly, the service serving robot can autonomously drive in a specific space according to a specific signal.

The driving space creation module (310) includes:
a SLAM execution element (311) for creating and generating a map of a real-time location and a particular space based on the information obtained from various sensors formed on the service serving robot (sensors required to acquire driving space information), IMU, and Odometry;
a creation map correction element (312) for correcting the map of a particular space prepared and created by the SLAM execution element (311) to improve the accuracy of the driving and operation of the serving robot;
a creation map 2D conversion element (313) for converting 3D information about the surrounding environment generated by various sensors formed on the service serving robot (sensors required to acquire driving space information) into 2D information; and
a final driving space map creation element (314) for creating a driving space map of the serving robot by integrating a result of RTAB-MAP and results of the SLAM execution element (311), the creation map correction element (312), and the creation map 2D conversion element (313) into one 2D map.

Accordingly, so that the driving space map of the serving robot can be created.

The path setting module (320) includes:
a driving path execution element (321) for performing path planning and path following of the shortest distance according to an input of a target coordinate, to which a probability circle-based spatial search (PCSS) algorithm is applied;
a driving path validation element (322) for verifying the validity of an IMU dead reckoning and a driving position of the serving robot;
a local/global path return setting element (323) for setting a return of a local path and a global path by creating a local cost-map for obstacle recognition and avoidance by various sensors formed on the service serving robot (sensors required to acquire driving space information) while the serving robot is driving; and
a navigation difference calibration element (324) that performs navigation difference calibration of the serving robot, so that the global and local paths and the driving (navigation) of the service serving robot for them are established.

That is, in order for the serving robot to move to its destination, the global path and the local path are required.

The global path means the entire path from the starting point to the destination within the operating environment of the serving robot.

The local path refers to the generation of a local route such as obstacle avoidance by using information detected while the serving robot is moving.

The global path is necessary when the information on all areas of the driving environment is provided and the local path is necessary to ensure the safety of people, assets, and the environment from the serving robot serving close to people.

For reference, the word ‘tableware’ described in the present invention refer to tools such as spoons, scissors, tongs, etc., which are used in order that the customers can more easily enjoy the provided service.

The ‘driving stability’ of the service serving robot means the degree to which unexpected accidents do not occur in the service serving robot while driving.

The ‘driving stability’ of a service-serving robot refers to the degree of constant state in which the service-serving robot does not create a complicated situation in which it has to avoid an obstacle, the robot does not shaken, or the robot does not deviate from its path while driving.

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### INDUSTRIAL APPLICABILITY

The present invention relates to a square-shaped service serving robot with an excellent service provision utilization and can contribute to the promotion of the overall optimization industry of the service robots related to robot hardware and software and program execution developed and manufactured for the main purpose of service, in particular, the development of hardware for self-driving service robots to perform various functions.

1. A square-shaped service serving robot (1) with an excellent service provision space utilization comprising:
a service serving tray housing means (100) formed in a rectangular shape and providing a tableware return functions to customers; and
a serving robot driving means (200) that is located and formed at a lower end of the service serving tray housing means (100), and moves, waits, and stops along a destination or a path input and transmitted from an outside to provide various services and the tableware return function to customers through the service serving tray housing means (100),
wherein the service serving tray housing means (100) and serving robot driving means (200) are formed in a layered structure to provide various services and the tableware return function to the customers,
wherein the service serving tray housing means (100) includes:
a service serving tray base frame housing (H) formed of a rectangular base frame and passed through a center of the base frame;
a first service providing means (110) that is located at an upper end of the service serving tray base frame housing (H) and has one or more service providing holder grooves (CH) formed with a certain diameter and a certain depth so as to exclusively provide drinks and utensils to the customers;
a second service providing means (120) that is located at a lower portion of the first service providing means (110) and having one or more service providing trays (TR) formed in a layered structure so as to provide various services to the customers; and
a third service providing means (130) that is located at a lower portion of the second service providing means (120), provides various services to the customers in the same way as the second service providing means (120), and outputs real-time status information of the service serving tray housing means (100), so that the store manager can intuitively recognize the real-time status information on the service serving tray housing means (100), and
wherein, through the square-shaped service serving tray housing means (100) and the service providing tray (TR), a utilization of the service providing space is maximized, so that various services can be easily provided to the customers.

2. The square-shaped service serving robot according to claim 1,
wherein on one side of the upper portion of the service serving tray housing means (100), a first sensor element (114) is configured, so that real-time obstacles located within a certain range in upper and lower directions based on an arbitrary upper side of the service serving robot can be recognized and avoided, when the service serving robot is driving; and
on one side of the upper portion of the service serving robot driving means (200), a second sensor element (230) is configured, so that real-time obstacles located within a certain range in upper and lower directions and driving floor status information thereof based on an arbitrary lower side of the service serving robot can be recognized and avoided, when driving the service serving robot, so that it maximizes the driving safety and stability of the service serving robot by securing the field of view necessary for driving and obstacle avoidance of the service serving robot.

3. The square-shaped service serving robot according to claim 1,
wherein, depending on the situation, the service providing tray (TR) for providing various services to the customers is placed on the upper portion of the first service providing means (110), so that it can be utilized as the same function as the second service providing means (120) and the third service providing means (130) that provide the services to the customers, so that it promotes easy structural change of the serving robot service, thereby maximizing utilization and effectiveness of the service serving robot.

4. The square-shaped service serving robot according to claim 1,
wherein the first service providing means (110), the second service providing means (120), and the third service providing means (130) are provided with the service providing trays (TR) for providing various services to the customers and the tableware return function activation bowls (BW) capable of collecting the remaining tableware after the service is completed by the customers respectively, depending on circumstances, so that it promotes easy structural change of the serving robot service providing means (100) according to the situation, thereby providing various services as well as activating the tableware return function.
